(19) United States
(12) Patent Application Publication
(10) Pub. No.: US 2024/0111036 A1
(43) Pub. Date: Apr. 4, 2024

(54) POLARIZATION-BASED LIGHT EMISSION AND DETECTION IN A LIDAR SYSTEM

(71) Applicant: OSRAM GmbH, Munich (DE)

(72) Inventor: Martin Schnarrenberger, Berlin (DE)

(21) Appl. No.: 18/257,550

(22) PCT Filed: Dec. 17, 2021
(86) PCT No.: PCT/EP2021/086401

§ 371 Date: Jun. 14, 2023

(30) Foreign Application Priority Data
Dec. 18, 2020 (DE) 10 2020 134 194.6

(51) Int. Cl. G01S 7/499; G01S 7/481

(52) U.S. Cl. CPC G01S 7/499; G01S 7/4814; G01S 7/4816; G01S 7/4817

(57) ABSTRACT

In an embodiment a LIDAR system includes a light emission system having a light deflection device configured to receive polarized light and to deflect the received light towards a first direction in accordance with a polarization of the received light and an optical arrangement configured to absorb or reflect a second portion of the light deflected by the light deflection device travelling in a second direction based on a polarization of the second portion of the deflected light.

### CROSS-REFERENCE TO RELATED APPLICATIONS

This patent application is a national phase filing under section 371 of PCT/EP2021/086401, filed Dec. 17, 2021, which claims the priority of German patent application 102020134194.6, filed Dec. 18, 2020, each of which is incorporated herein by reference in its entirety.

### TECHNICAL FIELD

Various aspects are related to a light emission system for use in a LIDAR (“Light Detection and Ranging”) system, and various aspects are related to a light detection system for use in a LIDAR system.

### BACKGROUND

Light detection and ranging is a sensing technique that is used, for example, in the field of autonomous driving for providing detailed information about the surrounding of an automated or partially automated vehicle. LIDAR light (e.g., laser light) is used to scan a scene and determine the properties (e.g., the location, the speed, the direction of motion, and the like) of the objects present therein. Various strategies and devices exist for controlling the scanning of the scene, i.e. for controlling the direction of the emitted light in a LIDAR system. An example is beam steering based on the polarization of the LIDAR light, for example using a liquid crystal polarization grating (LCPG), which may provide coarse and fine control over an emission angle of the LIDAR light. A liquid crystal polarization grating commonly operates with circularly polarized light, and provides different deflection directions for the two possible rotation directions (i.e., clockwise and counter-clockwise) of the circularly polarized light. In a LIDAR system employing a liquid crystal polarization grating, the LIDAR light is deflected towards the field of view of the LIDAR system along a main emission direction (as main light or main beam) according to its circular polarization. In addition to the LIDAR light travelling in the main emission direction, a portion of the LIDAR light may be deflected towards a secondary emission direction (as secondary light or as a secondary beam). A LIDAR system may usually not include any measure or mechanism for attenuating or eliminating the emission of light in the secondary direction.

### SUMMARY

Various aspects may be based on the realization that the light emitted in the secondary emission direction (also referred to in the following as secondary direction), or in general in an emission direction other than the main emission direction (also referred to in the following as main direction), may disturb the operation of a LIDAR system, since at the receiver side the secondary beam may be indistinguishable from the main beam, i.e. it may not be possible to distinguish whether LIDAR light arriving at a detector of the LIDAR system originated from the undesired (secondary) emission direction or from the desired (main) emission direction. This may lead, for example, to a wrong localization of an object in the field of view of the LIDAR system, e.g. an object determined to be along the main emission direction may actually be located along the secondary emission direction.

Various aspects are related to a LIDAR system in which the disturbing effects associated with LIDAR light emitted into a direction other than the desired emission direction are reduced or substantially eliminated. Illustratively, various aspects are related to an adapted LIDAR system, e.g. a LIDAR system including an adapted light emission system and/or an adapted light detection system, configured to attenuate or block secondary light (e.g., light emitted in a secondary direction, or light coming from a secondary direction). The light emission system and the light detection system may provide, alone or in combination with one another, an improved operation of the LIDAR system, for example reducing the amount of (undesired) light arriving at the detector, thus reducing the dynamic range of the detector, and/or providing a more accurate object recognition.

Various aspects are related to a light emission system (for use in a LIDAR system) adapted to attenuate or block the emission of light in directions other than a desired emission direction, based on the polarization of the emitted light. Illustratively, various aspects are related to a polarization-based light emission, in which light having a polarization other than the polarization of light emitted (or to be emitted) in a main emission direction is attenuated or blocked. In various aspects, the light emission system may include: a light deflection device configured to receive polarized light, and configured to deflect the received light towards a first direction in accordance with the polarization of the received light; and an optical arrangement configured to absorb or reflect a secondary portion of the light deflected by the light deflection device travelling in a second direction, based on a polarization of the secondary portion of the deflected light.

Various aspects are related to a light detection system adapted to attenuate or block LIDAR light arriving at the detection system from directions other than a main emission direction of the LIDAR system, based on the polarization of the received light. Illustratively, various aspects are related to a polarization-based light detection, in which received light having a polarization other than the polarization of the light emitted in a main emission direction is attenuated or blocked. In various aspects, the light detection system may operate in combination with the light emission system. In various aspects, the light detection system may include: a first optical component configured to receive polarized light from the field of view of the LIDAR system, the first optical component being configured to convert the type of the polarization of the received light; and a light deflection device configured to deflect the light output by the first optical component in accordance with the polarization of the light output by the first optical component.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various aspects disclosed herein are described with reference to the following drawings, in which:

FIG. 1 shows schematically a LIDAR system according to various aspects;

FIG. 2 shows schematically a LIDAR system according to various aspects;

FIG. 3A and FIG. 3B each shows schematically a light deflection device according to various aspects;

FIG. 3C to FIG. 3E each shows schematically a respective optical component according to various aspects;

FIG. 4A shows schematically a light emission system according to various aspects;

FIG. 4B shows schematically an optical arrangement according to various aspects;

FIG. 4C shows schematically a light emission system according to various aspects;

FIG. 5A to FIG. 5D each shows schematically a light detection system according to various aspects; and

FIG. 6A to FIG. 6D each shows schematically a LIDAR system according to various aspects.

### DETAILED DESCRIPTION OF ILLUSTRATIVE EMBODIMENTS

The following detailed description refers to the accompanying drawings that show, byway of illustration, specific details and aspects disclosed herein. These aspects are described in sufficient detail to enable those skilled in the art to practice the disclosed implementations. Other aspects may be utilized and structural, logical, and electrical changes may be made without departing from the scope of the disclosed implementations. The various aspects are not necessarily mutually exclusive, as some aspects may be combined with one or more other aspects to form new aspects. Various aspects are described in connection with methods and various aspects are described in connection with systems (e.g., a LIDAR system, a light emission system, or a light detection system). However, it is understood that aspects described in connection with methods may similarly apply to the systems, and vice versa.

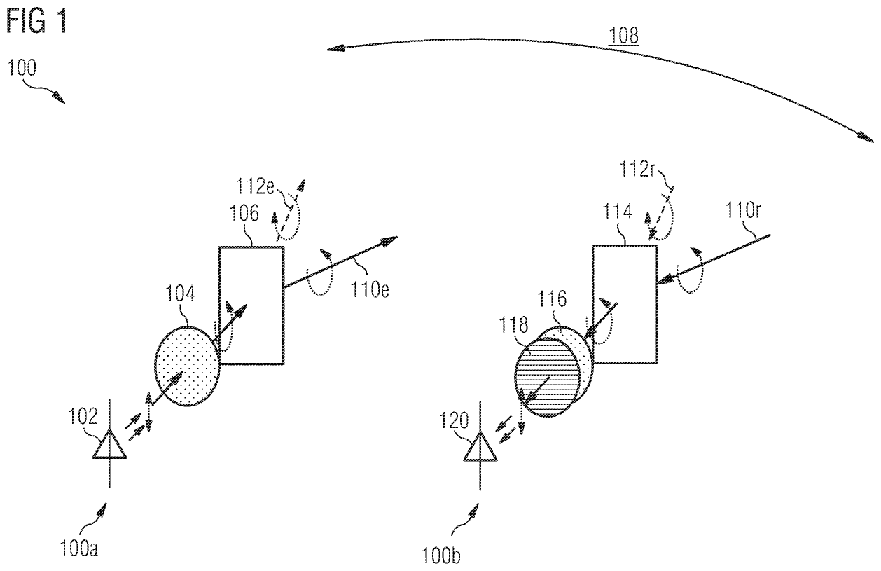

FIG. 1 shows schematically a LIDAR system 100 according to various aspects.

The LIDAR system 100 may include, at the emitter side 100a, a laser source 102 emitting linearly polarized light, a quarter-wave plate 104 converting the linearly polarized light into circularly polarized light (e.g., into counter-clockwise circularly polarized light), and a liquid crystal polarization grating 106 deflecting the circularly polarized light towards a field of view 108 of the LIDAR system 100.

The liquid crystal polarization grating 106 may deflect light towards a main emission direction 110e, the light having a same circular polarization as the light input to the liquid crystal polarization grating 106. Secondary light may remain that is emitted with opposite circular polarization (e.g., clockwise circularly polarized light) towards a secondary emission direction 112e. The secondary light may be present, for example, due to an incomplete switching of the liquid crystals in the polarization grating 106, which may cause an incomplete steering of the light, so that not all the light is deflected into the desired emission direction 110e. The incomplete switching of the liquid crystals may be caused, for example, by imperfections of the grating or the liquid crystal, imperfect alignment of the components, or others.

The LIDAR system 100 may receive, at the receiver side 100b, light coming from the main emission direction 110r (illustratively, light originating from the direct reflection of the light emitted towards the main emission direction 110e) and light coming from the secondary emission direction 112r (illustratively, light originating from the direct reflection of the light emitted towards the secondary emission direction 112e). The light arriving at the receiver side may have been reflected by a mirroring surface, so that it has opposite handedness with respect to the light emitted in that direction. The LIDAR system 100 may include, at the receiver side 100b, a liquid crystal polarization grating 114 directing the received light towards a detector 120, a quarter-wave plate 116 converting the circularly polarized light received at the receiver side 100b into linearly polarized light, and a polarizer 118 blocking the received light that has the opposite polarization of the light that is led from the main direction 110r through the liquid crystal polarization grating 114 and quarter-wave plate 116 towards the receiving detector 120 (e.g., the receiving photo diode). The quarter-wave plate 116 and the polarizer 118 act as a polarization filter that allows the signal from the main direction 110r to pass through towards the detector 120, and at least partially blocks the signal from the secondary direction 112r.

In a LIDAR system configured as the LIDAR system 100 there may be no mechanism or device to block the emission of light in the secondary direction 112e (or in general in directions other than the main emission direction 110e). The success of the LIDAR measurement may thus rely on the quality of the liquid crystal polarization grating 106, with the risk that a faulty or incomplete switching of the liquid crystals may lead to inaccurate object detection (e.g., in case the light coming from the secondary direction 112r disturbs the detection at the receiver side 100b).

In addition, in the LIDAR system 100, most of the polarized light coming from retroreflective or mirroring objects (along the undesired secondary direction 112r) is not blocked by the quarter-wave plate 116 and the polarizer 118, and arrives on the detector 120, thus leading to a strong signal from such objects located along the undesired direction, which may reduce the accuracy of an object recognition process. The configuration of the LIDAR system 100 also does not enable the evaluation of the proportion of polarization that is maintained through the reflection of the emitted light by an object in the field of view 108.

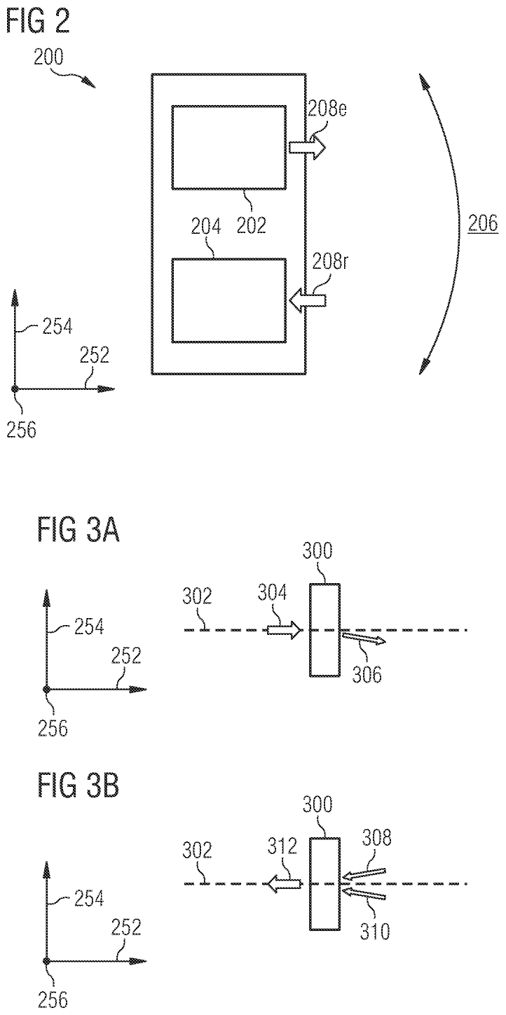

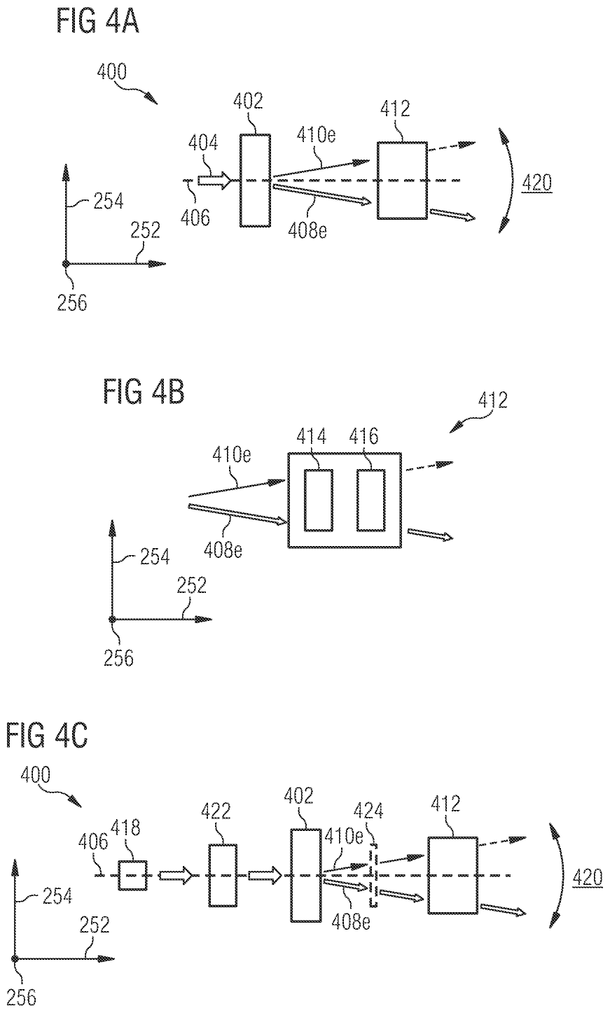

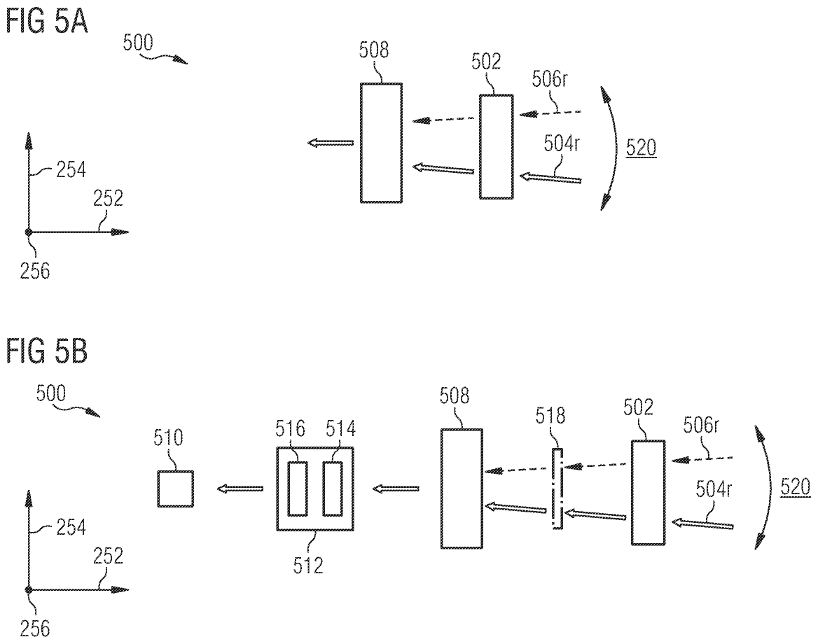

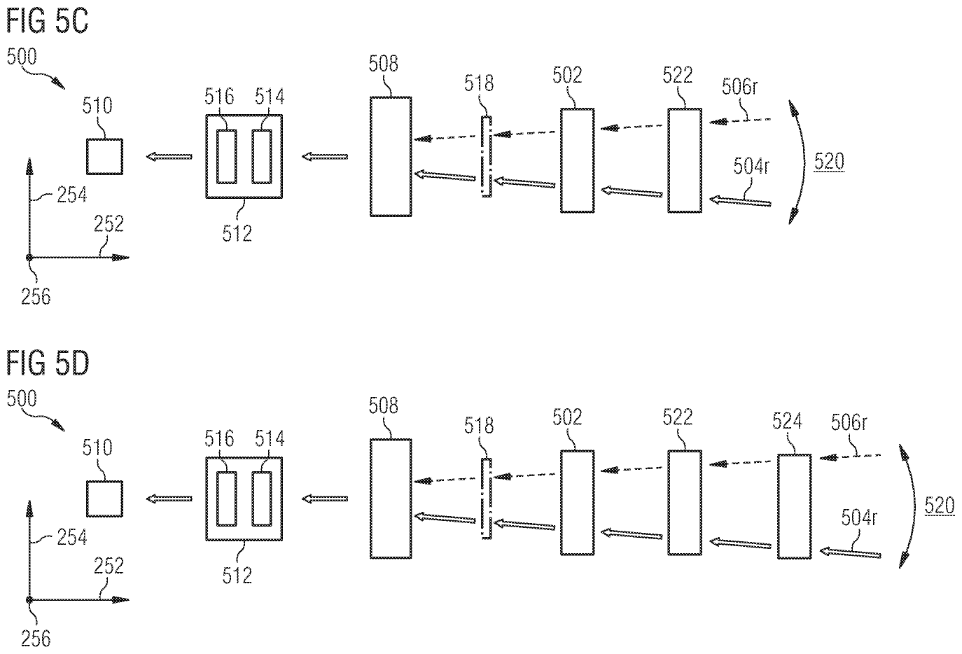

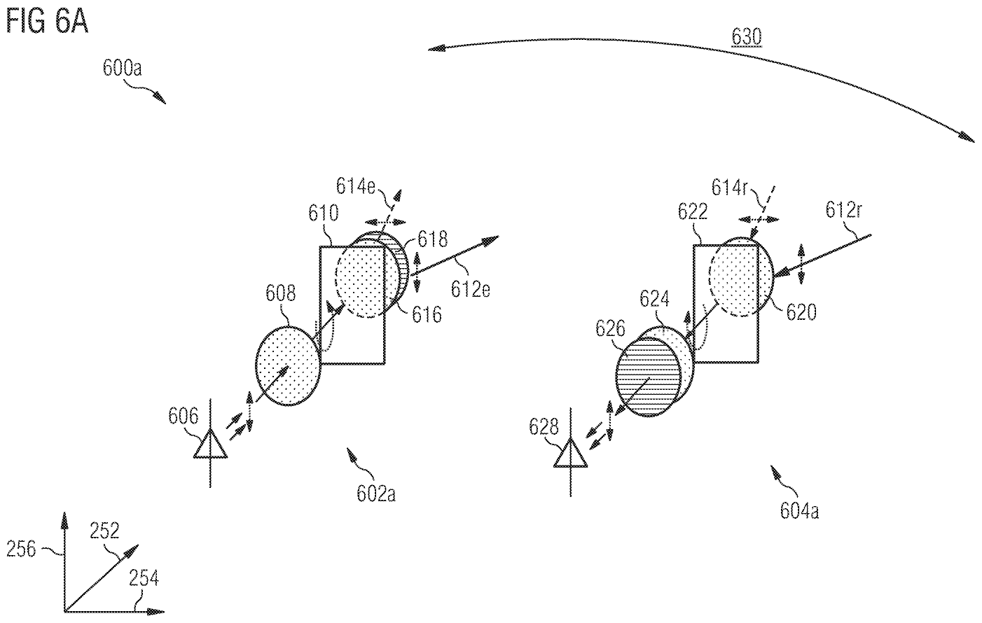

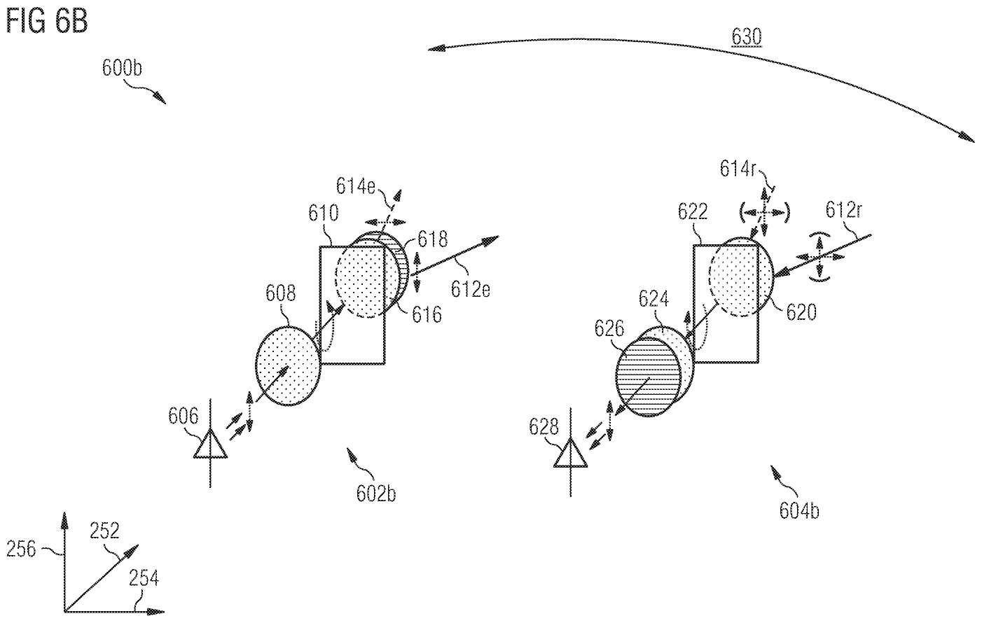

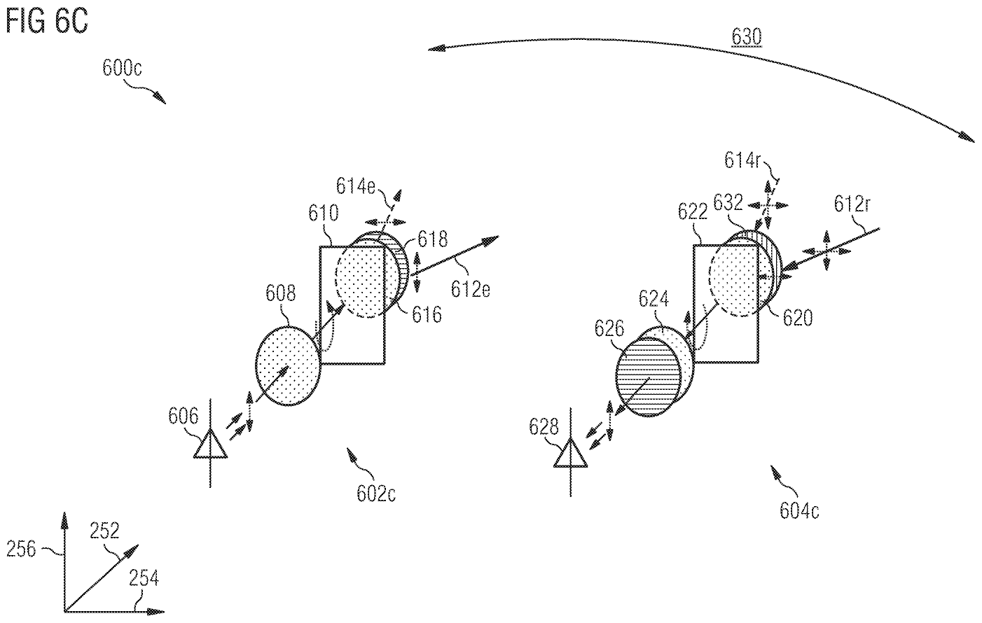

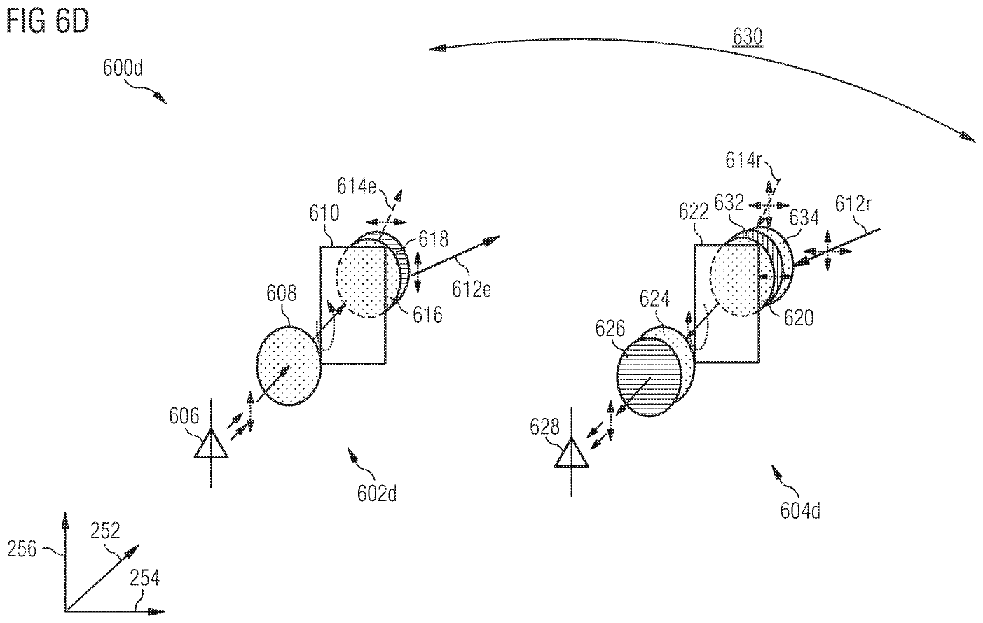

Various aspects are related to an adapted light emission system (and an adapted light emission method) providing a polarization-based attenuation or a suppression of light emitted (or that would be emitted) in directions other than a desired emission direction, as described for example in relation to FIG. 4A to FIG. 4C. Various aspects are related to an adapted light detection system (and a light detection method) providing a polarization-based attenuation or a suppression of effects associated with light coming from directions other than a desired emission direction, as described for example in relation to FIG. 5A to FIG. 5D. Various aspects may be related to an adapted LIDAR system including an adapted light emission system and/or an adapted light detection system, as described for example in FIG. 2 and in FIG. 6A to FIG. 6D.

In the following, reference is made to a LIDAR system. It is however understood that a LIDAR system is only an example of a possible application of the light emission system and of the light detection system described herein. The light emission system and the light detection system may also be used in other types of applications or systems in which the polarization-based light emission and detection described herein may provide an improved operation (e.g., an operation with less noise, or with more accurate object identification, as examples).

In the following, in various aspects, a liquid crystal polarization grating is described to control an emission direction of emitted light, or to control a propagation direction of received light, based on the polarization of the light. It is however understood that a liquid crystal polarization grating is only an example, and other polarization-based devices or arrangements for controlling the emitted or received light may be used (for example, one or more polarization gratings mounted on mechanical supports that allow moving and/or rotating the polarization gratings).

The terms “optically downstream” or “optically upstream” as used herein may describe a relative arrangement between two elements, in which a first element arranged optically downstream of a second element receives the light output by the second element, and in which a first element arranged optically upstream of a second element outputs light in direction of the second element. The terms “optically downstream” and “optically upstream” as used herein may describe the relative arrangement between the two elements along the optical path of the light, without implying any physical or spatial relationship between the arrangement of the first element and of the second element. Illustratively, a first element arranged optically downstream of a second element may be arranged physically (spatially) downstream of the second element, e.g. with or without additional elements therebetween, or may be arranged physically upstream of or at a same level as the second element, with optical elements guiding the light from the second element to the first element. Similarly, a first element arranged optically upstream of a second element may be arranged physically upstream of the second element, e.g. with or without additional elements therebetween, or may be arranged physically downstream of or at a same level as the second element, with optical elements guiding the light from the first element to the second element.

The term “polarization type” or “type of polarization” as used herein may describe a classification of the polarization of light, as commonly understood in the art. A “polarization type” or “type of polarization” as used herein may include a linear polarization, a circular polarization, or an elliptical polarization. In some aspects, light described as “having a certain (e.g., first or second) polarization” may be understood as light having mostly that polarization. For example, light having a first polarization may be understood as light having a mix of polarizations in which the first polarization is predominant (e.g., the first polarization represents more than 70% of the mix of polarizations, of more than 90%, or substantially 100%). Illustratively, light as “having a certain (e.g., first or second) polarization” may be understood, in some aspects, as light including that polarization and possibly other polarization components that may however be substantially neglected.

The term “handedness” as used herein may describe the direction of rotation of the electric field vector associated with circularly polarized light in a plane perpendicular to the propagation direction of the light (e.g., in a plane perpendicular to a main emission direction or in a plane perpendicular to a secondary emission direction). Illustratively, light having a circular polarization with a certain handedness may be understood as light being right-handed (or clockwise) circularly polarized or as light being left-handed (or counter-clockwise) circularly polarized. By way of example, light having a circular polarization with a first handedness may be right-handed circularly polarized light, and light having a circular polarization with a second handedness may be left-handed circularly polarized light, or vice versa.

Light arriving from an emission direction may be understood herein as light originating from the light emitted into that emission direction and reflected back towards the light detection system (in some aspects, towards the LIDAR system). Illustratively, light arriving from an emission direction may be understood herein as the (e.g., direct) reflection of light emitted into that direction. Herein, the subscript “e” may be associated with a direction (e.g., an emission direction) into which light is emitted, and the subscript “r” may be associated with a direction from which light is received. A direction into which light is emitted may be the same as a direction from which light is received, with the difference being the sense into which the light is traveling along that direction.

In the following, reference is made to optical components and optical arrangements. It is understood that the implementations described herein are only an exemplary realization of the optical components and arrangements to provide the respective functionalities, but also other configurations may be possible. In other words, the functionalities described herein in association with an optical component or with an optical arrangement may also be realized by means of other optical components or arrangements, e.g. by a combination of other optical components that together provide the same functionality. Illustratively, an optical component may also be understood as including one or more optical components to provide the desired functionality.

FIG. 2 shows a schematic top view of a LIDAR system 200 according to various aspects. The LIDAR system 200 may be used for sensing to assist a driving operation, as an example. A vehicle, such as an automated vehicle, may include one or more LIDAR systems 200. It is understood that the configuration shown in FIG. 2 may be simplified for the purpose of explanation, and that the LIDAR system 200 may include additional components with respect to those shown. By way of example, the LIDAR system 200 may include one or more processors, one or more controllers, a memory, etc., not shown in FIG. 2.

The LIDAR system 200 may include a light emission system 202 configured to emit light into (in other words, towards) a field of view 206 of the LIDAR system 200. The LIDAR system 200 may include a light detection system 204 configured to detect light from the field of view 206 of the LIDAR system 200. The field of view 206 of the LIDAR system 200 may be or may correspond to the field of view of the light emission system 202 (also referred to as field of emission) and/or to the field of view of the light detection system 204. The field of emission of the light emission system 202 may substantially correspond to the field of view of the light detection system 204.

In some aspects, the light emission system 202 may be configured to direct light into the field of view 206 by means of polarization-based beam steering, and may be configured to attenuate or block the emission of light towards other directions than a main emission direction 208e, as described in further detail below, for example in relation to FIG. 4A to FIG. 4C. The light emission system 202 may be configured to direct light into the field of view 206 at an angle with respect to an optical axis of the light emission system 202. The optical axis may be aligned along a first direction 252. In some aspects, the light emission system 202 may be configured to sequentially direct the light into the field of view 206 at different angles to scan the field of view 206 along a second (e.g., horizontal) direction 254 and/or along a third (e.g., vertical) direction 256, and/or along any other direction.

In some aspects, the light detection system 204 may be configured in such a way that light arriving from directions not associated with a main emission direction 208r of the LIDAR system 200 may be attenuated or blocked depending on the polarization of the received light, as described in further detail below, for example in relation to FIG. 5A to FIG. 5D.

In some aspects, the light detection system 204 may be configured in such a way that light originating from retroreflective objects may be distinguished from light originating from diffuse reflective objects. This may provide information to assist an object recognition and/or identification process, as described in further detail below. In some aspects, the light detection system 204 may be configured in such a way that light coming from retroreflective or mirroring objects may be attenuated, thus providing a more efficient detection, e.g. it may avoid or reduce an overdrive of the detector caused by the strong reflection.

In some aspects, the light detection system 204 may be configured in such a way that the portion of light arriving at the light detection system 204 with unaltered polarization (with respect to the emitted light) upon reflection from an object in the field of view 206 may be determined, as described in further detail below. Illustratively, the size of the polarization-maintaining portion of the light coming from the reflection from an object may be determined. This may assist an object recognition or identification process.

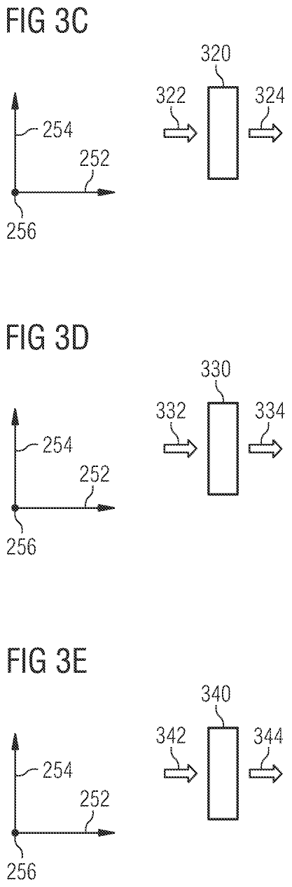

FIG. 3A, FIG. 3B, FIG. 3C, FIG. 3D, and FIG. 3E show schematically possible components that may be used in a light emission system (e.g., in the light emission system 202, and/or in the light emission system 400 described in further detail below) and/or in a light detection system (e.g., in the light emission system 204, and/or in the light emission system 500 described in further detail below).

FIG. 3A and FIG. 3B show schematically an optical component 300, e.g. a light deflection device 300 (also referred to herein as beam steering device or angle steering device), according to various aspects.

The light deflection device 300 may be configured to perform polarization-based control of a propagation direction of light arriving at the light deflection device 300. The light deflection device 300 may be configured to receive polarized light, and may be configured to control a propagation direction also referred to herein as emission direction) of the received light in accordance with the polarization of the received light. As shown, for example, in FIG. 3A, the light deflection device 300 may be configured to receive polarized light 304, and to deflect the received light into an emission direction 306 in accordance with the polarization of the received light 304. In the following, light output by a light deflection device may also be referred to as deflected light.

The light deflection device 300 may be configured to output the received light (as deflected light) at a deflection angle that is associated with (e.g., dependent on) the polarization of the received light. The deflection angle may be an angle with respect to an optical axis 302 of the light deflection device 300, for example aligned along a first direction 252. The deflection angle may be an angle in a horizontal direction 254, and/or an angle in a vertical direction 256 (in some aspects, a light deflection device may be used for one-dimensional or two-dimensional scanning of a field of view of a LIDAR system, e.g. of the field of view 206).

In some aspects, the light deflection device 300 may be configured to control a propagation direction of the received light based on one or more properties of the polarization of the received light, such that light having polarization with different properties is deflected into different directions. This is illustrated, for example, in FIG. 3B. The light arriving at the light deflection device 300 may include a first portion 308 (arriving from a first direction), and a second portion 310 (arriving from a second direction). The polarization of the light of the first portion 308 may have at least one property different from the polarization of the light of the second portion 310. In case the properties have opposite values with respect to one another, the light of the first portion 308 may be deflected at an opposite deflection angle with respect to the optical axis 302 compared to the light of the second portion 310. The first portion 308 and the second portion 310 may be deflected as deflected light 312 into a same direction downstream of the light deflection device 300. In this case, the deflected light 312 may include a first portion with a first polarization and a second portion with a second polarization traveling into a same direction.

In some aspects, the light deflection device 300 may be configured to not alter a polarization type of the received light. Byway of example, the received light may have a polarization of a certain type (e.g., of a first type, for example circular) and the deflected light may have a polarization of the same (first) type.

In some aspects, the light deflection device 300 may be configured to operate with circularly polarized light. The light received at the light deflection device 300 may be circularly polarized. The light deflection device 300 may be configured to deflect the received light in accordance with the handedness of the circular polarization. Illustratively, the deflection angle may be dependent on the handedness of the circular polarization. Illustratively, the light deflection device 300 may be configured to provide a first (e.g., positive) angle with respect to the optical axis 302 in case the received light is right-handed circularly polarized and to provide a second (opposite the first, e.g. negative) angle with respect to the optical axis 302 in case the received light is left-handed circularly polarized. With reference, for example, to FIG. 3B, the first portion 308 of the light received at the light deflection device 300 may have a first circular polarization having a first handedness and the second portion 310 of the light received at the light deflection device 300 may have a second circular polarization having a second handedness (opposite the first handedness), and the first portion and the second portion may be deflected by an angle with respect to the optical axis 302 having a same value but opposite sign, so that both portions are deflected along a same direction downstream of the light deflection device 300. Only as an example, the first portion 308 of the light received at the light deflection device 300 may include right-handed circularly polarized light, and the second portion 310 of the received light may include left-handed circularly polarized light.

In some aspects, the light deflection device 300 may be configured to deflect the received light into different directions, e.g. may be configured to provide different deflection angles over time. This may provide, for example, a one-dimensional or two-dimensional scanning the field of emission of a light emission system and/or of the field of view of a LIDAR system, as described in further detail below. The light deflection device 300 may be configured to assume a plurality of states, each associated with a respective direction into which the received light is deflected, e.g. each associated with a respective deflection angle. Illustratively, the light deflection device 300 may be configured, in a first state, to deflect the received light into one direction, and, in a second state, to deflect the received light into another direction. By way of example, the light deflection device 300 may be coupled with one or more processors (not shown) configured to control the light deflection device 300, e.g. to control a state of the light deflection device 300.

In some aspects, the light deflection device 300 may include a switchable optical component, for example a switchable liquid crystal component. In some aspects, the light deflection device 300 may include a liquid crystal polarization grating. A grating period of the liquid crystal polarization grating may define the deflection angle. The grating period may be changed by providing a control signal (e.g., a control voltage, such as a DC voltage that is switched on and off) at the liquid crystal polarization grating. The control signal may define an orientation of the liquid crystals, thus defining a respective grating period of the polarization grating.

In some aspects, the light deflection device 300 may include a liquid crystal layer and a polarization grating. The liquid crystal layer may be configured to define a polarization of the light, so that the light may then be deflected towards a desired direction by the polarization grating (based on its grating period, which may be fixed in this configuration). Illustratively, the orientation of the liquid crystals may be controlled to define a desired polarization.

FIG. 3C shows schematically an optical component 320 (also referred to herein as polarization control component) according to various aspects.

The optical component 320 may be configured to change a type of the polarization of light 322 arriving at the optical component 320 (also referred to herein as received light 322 or input light 322). In other words, the optical component 320 may be configured to alter a polarization state of the polarization of light 322 arriving at the optical component 320. The first optical component 320 may be configured to convert the type of the polarization of the received light 322 from a first type to a second type (different from the first type) and/or from the second type to the first type. In some aspects, the optical component 320 may be configured to convert linearly polarized light into circularly polarized light and/or to convert circularly polarized light into linearly polarized light.

The optical component 320 may be configured such that one or more properties of the polarization of the light 324 output by the optical component 320 depend on one or more properties of the polarization of the light 322 received at the optical component 320. The optical component 320 may be configured such that a direction along which a linear polarization of the output light 324 is aligned is associated with the handedness of the circular polarization of the received light 322. Correspondingly, the optical component 320 may be configured such that the handedness of a circular polarization of the output light 324 is associated with a direction along which a linear polarization of the received light 322 is aligned. Illustratively, the optical component 320 may be configured to convert received light 322 having a first linear polarization aligned in a first direction (e.g., the vertical direction 256) into output light 324 having a first circular polarization with a first handedness. The optical component 320 may be configured to convert received light 322 having a second linear polarization aligned in a second direction (e.g., perpendicular to the first direction, e.g. the horizontal direction 254) into output light 324 having a second circular polarization with a second handedness (e.g., opposite the first handedness). Further illustratively, the optical component 320 may be configured to convert received light 322 having a first circular polarization with a first handedness into output light 324 having a first linear polarization aligned into a first direction, and to convert received light 322 having a second circular polarization with a second handedness (opposite the first handedness) into output light 324 having a second linear polarization aligned into a second direction (perpendicular to the first direction). Both the first direction and the second direction may be perpendicular to a direction along which the output light is traveling. Illustratively, the optical component 320 may be configured to provide a λ/4 (lambda/4) phase shift to the received light 322.

In some aspects, the optical component 320 may include a retarder, such as a quarter-wave plate (in other words, a λ/4 plate). In various aspects, the axis of the quarter-wave plate may be oriented at 450 with respect to the polarization of the received light 322.

FIG. 3D shows schematically an optical component 330 (also referred to herein as polarization filtering component) according to various aspects.

The optical component 330 may be configured to let through, absorb, or reflect light 332 received at the optical component 330 in accordance with the polarization of the received light.

The optical component 330 may be configured to absorb or reflect light having a predefined polarization (illustratively, may be configured to allow through light having a polarization different from the predefined polarization and to attenuate or block light having the predefined polarization). A predefined polarization may be understood herein as a polarization having one or more predefined properties (e.g., a predefined handedness).

Illustratively, the optical component 330 may be configured such that less than 100% of light having the predefined polarization passes through the optical component 330, for example less than 50% of the light, or less than 10%, or less than 1%. The optical component 330 may be configured such that received light having a polarization different from the predefined polarization may pass through as output light 334.

In some aspects, the optical component 330 may be configured to absorb or reflect light having a predefined linear polarization (and to let through light having a linear polarization different from the predefined linear polarization). Illustratively, the optical component 330 may be a polarization filter for the predefined linear polarization. The optical component 330 may be configured to absorb or reflect light having a predefined linear polarization aligned along a predefined direction, and to let through light having a linear polarization aligned along another direction different from the predefined direction. In case the other direction is perpendicular to the predefined direction, the optical component 330 may let through substantially oo % of the light.

In some aspects, the optical component 330 may include a polarizer. The polarizer may be oriented along a first orientation direction perpendicular to the direction along which the linear polarization to be blocked is aligned (and/or parallel to the direction along which a linear polarization to be let through is aligned).

FIG. 3E shows schematically a switchable optical component 340 (also referred to herein as switchable polarization control component) according to various aspects.

The switchable optical component 340 may be configured to change one or more properties of a polarization of light 342 received at the switchable optical component 340. The switchable optical component 340 may be configured, in a first state, to change one or more properties of the polarization of the received light 342, and, in a second state, to leave the polarization of the received light 342 substantially unaltered. The light 344 output from the switchable optical component 340 may have the same polarization as the received light 342 (in case the switchable optical component 340 is in the second state), or a polarization with one or more different properties compared to the polarization of the received light 342 (in case the switchable optical component 340 is in the first state). In some aspects, the optical component 320 may be configured (in the first state) to provide a λ/2 (lambda/2) phase shift to the received light 342.

The switchable optical component 340 may be coupled with one or more processors (not shown) configured to control the switchable optical component 340, e.g. to control a state of the switchable optical component 340 (to bring it into the first state or in the second state). Illustratively, the switchable optical component 340 may be configured (and controlled) such that the light 344 output by the switchable optical component 340 has predefined properties. The switchable optical component 340 may be controlled to change the one or more properties of the polarization of the received light 342 in case the polarization of the received light 342 is different from the predefined polarization.

In some aspects, the switchable optical component 340 may be configured (in the first state) to control a direction along which a linear polarization of the output light 344 is aligned. Illustratively, the switchable optical component 340 may be configured to receive light 342 having a first linear polarization aligned along a first direction (e.g., along the vertical direction 256), and may be configured to output light 344 having a second linear polarization aligned along a second direction (e.g., different from the first direction, for example perpendicular to the first direction, such as the horizontal direction 254). In the second state, the switchable optical component 340 may be configured such that the second linear polarization of the output light 344 is aligned along the first direction.

In some aspects, the switchable optical component 340 may be configured (in the first state) to control a handedness of a circular polarization of the output light 344. Illustratively, the switchable optical component 340 may be configured to receive light 342 having a first circular polarization with a first handedness (e.g., right-handed circularly polarized light), and may be configured to output light 344 having a second circular polarization with a second handedness (e.g., opposite the first handedness, for example left-handed circularly polarized light). In the second state, the switchable optical component 340 may be configured such that the second handedness of the output light 344 has the same sense of rotation as the first handedness.

In some aspects, the switchable optical component 340 may be integrated (e.g., laminated) into a light deflection device, for example in the light deflection device 300. In this case, the switchable optical component 340 may be controlled (e.g., brought into the first state or in the second state) by the same one or more processors controlling the light deflection device 300.

In some aspects, the switchable optical component 340 may include a retarder, such as a half-wave plate. The retarder may be a variable (or switchable) retarder. In some aspects, the switchable optical component 340 may include a liquid crystal component, e.g. a liquid crystal half-wave plate (a liquid crystal retarder, for example a half-wave liquid crystal variable retarder). As a further example, the switchable optical component 340 may include a switchable λ/4 plate or a switchable retarder between (¼)λ and (¾)λ.

In the following, a light emission system (for example with reference to FIG. 4A to FIG. 4C), and a light detection system (for example with reference to FIG. 5A to FIG. 5D) are described, in which one or more of the components described in relation to FIG. 3A to FIG. 3E may be provided.

FIG. 4A shows a light emission system 400 in a schematic view according to various aspects. The light emission system 400 may be for use in a LIDAR system, e.g. the light emission system 400 may be an exemplary implementation of the light emission system 202 of the LIDAR system 200 described in relation to FIG. 2.

The light emission system 400 may include a light deflection device 402 configured to receive polarized light 404 and to deflect the received light 404 in accordance with the polarization of the received light 404. The light deflection device 402 may be configured as the light deflection device 300 described in relation to FIG. 3A and FIG. 3B. The light deflection device 402 may be configured to direct light towards a field of emission 420 of the light emission system 400 (e.g., towards a field of view of a LIDAR system, e.g. towards the field of view 206).

In the exemplary configuration shown in FIG. 4A, the light deflection device 402 may be configured to deflect the received light 404 towards a first direction 408e (e.g., a main emission direction, illustratively as deflected light 408e towards the first direction 408e) in accordance with the polarization of the received light 404.

The light 404 received at the light deflection device 402 may have a first polarization (of a first polarization type), and the light deflection device 402 may be configured to deflect the received light in accordance with the first polarization. Illustratively, the light deflection device 402 may be configured to deflect the received light 404 at a deflection angle (with respect to an optical axis 406) associated with (e.g., dependent on) the first polarization.

In some aspects, the light 404 received at the light deflection device 402 may have a first circular polarization having a first handedness, and the first direction 408e may be associated with the first circular polarization (e.g., with the first handedness of the first circular polarization).

In some aspects, the light deflected by the light deflection device 402, illustratively the light optically downstream of the light deflection device 402, may include one or more further components in addition to the light deflected into the first direction 408e, i.e. may include light deflected into another direction (or in other directions) with respect to the first direction 408e.

In the exemplary configuration shown in FIG. 4A, the light deflected by the light deflection device 402 may include a first portion (also referred to as main portion) deflected towards the first direction 408e and a second portion (also referred to as secondary portion) deflected towards a second direction 410e (different from the first direction, also referred to as secondary direction). In some aspects, the second portion may be light deflected into the second direction 410e due to an incomplete switching of the liquid crystals of a liquid crystal element of the light deflection device 402. The light deflected in directions other than the first (main) direction 408e may be less than the light deflected in the first direction 408e, e.g. the second portion of the deflected light may have less intensity than the first portion of the deflected light. By way of example, the light deflected in the second direction 410e may be less than 10% of the total deflected light, or less than 5%, or less than 1%.

In some aspects, the light traveling in the first direction 408e (in other words, the light of the first portion) may have the first polarization (e.g., the same polarization as the received light 404, in some aspects the light of the first portion may have a (first) polarization different from the (first) polarization of the received light 404). The light traveling in the second direction 410e (in other words, the light of the second portion) may have a second polarization (different from the first polarization of the light traveling in the first direction 408e). The first polarization and the second polarization may be of the same polarization type (e.g., the first polarization type, as the received light 404), but may differ from one another in at least one property (e.g., in the handedness, e.g. the light of the first portion and the light of the second portion may have polarizations perpendicular to one another). The first direction 408e may be associated with the first polarization, and the second direction 410e may be associated with the second polarization. Illustratively, the light deflection device 402 may be configured such that the deflected light of the second portion has a second polarization, e.g. may be configured in such a way that a change in the polarization may occur in at least a portion of the deflected light (e.g., in the portion deflected into a direction other than the first direction 408e).

In some aspects, the first polarization may be a first circular polarization having a first handedness, and the second polarization may be a second circular polarization having a second handedness opposite the first handedness. Only as an example, the light traveling in the first direction 4o8e may be left-handed circularly polarized (e.g., in case the received light is left-handed circularly polarized), and the light traveling in the second direction 410e may be right-handed circularly polarized.

In some aspects, the light emission system 400 may include an optical arrangement 412 configured to attenuate or block light traveling in a direction other than the first direction 408e, based on the polarization of the light. In the configuration shown in FIG. 4A and FIG. 4C, the optical arrangement 412 may be configured to absorb or reflect the second portion of the light deflected by the light deflection device 402 travelling in the second direction 410e, based on the (second) polarization of the second portion of the deflected light. Illustratively, the optical arrangement 412 may be configured such that less than 100% of the light of the second portion passes through (in other words is transmitted through) the optical arrangement 412 into the field of emission 420, for example less than 50% of the light, or less than 10%, or less than 1%. The optical arrangement 412 may be configured to receive the light deflected by the light deflection device 402, e.g. the optical arrangement 412 may be arranged optically downstream of the light deflection device 402.

The optical arrangement 412 may be configured to let the first portion of the deflected light to pass through substantially unaltered. Illustratively, the optical arrangement 412 may be configured such that substantially the 100% of the light of the first portion passes through the optical arrangement 412 into the field of emission 420.

FIG. 4B shows schematically the optical arrangement 412 according to various aspects. It is understood that the configuration of the optical arrangement 412 shown in FIG. 4B is only an example, and the optical arrangement 412 may include additional, less, or alternative components with respect to those shown.

In some aspects, the optical arrangement 412 may include a first optical component 414 configured to change a type of the polarization of the light arriving at the first optical component 412. The first optical component 412 may be configured as the optical component 320 described in relation to FIG. 3C. The first optical component 414 may be configured to convert a type of the polarization of the light deflected by the light deflection device 402 (from the first type to a second type).

In some aspects, the first optical component 414 may be configured to convert the first polarization of the first portion of the deflected light from the first type to a second type, and the second polarization of the second portion of the deflected light from the first type to a second type. In some aspects, the first optical component 414 may be configured to convert the first circular polarization of the first portion of the deflected light having a first handedness into a first linear polarization aligned along a first direction, and to convert the second circular polarization of the second portion of the deflected light having a second handedness into a second linear polarization aligned along a second direction (e.g., perpendicular to the first direction). Only as an example, the first optical component 414 may be configured to convert left-handed circularly polarized light of the first portion of the deflected light into linearly polarized with polarization aligned along the vertical direction 256, and to convert right-handed circularly polarized light of the second portion of the deflected light into linearly polarized with polarization aligned along the horizontal direction 254.

In some aspects, the optical arrangement 412 may include a second optical component 416 configured to let through, absorb, or reflect light received at the second optical component 416 in accordance with the polarization of the received light. The second optical component 416 may be configured as the optical component 330 described in relation to FIG. 3D. In some aspects, the second optical component 416 may be configured to receive the light output by the first optical component 414, illustratively the second optical component 416 may be arranged optically downstream of the first optical component 414.

The light output by the first optical component 414 may include the first portion of the deflected light having (downstream of the first optical component 414) a first polarization of a second type (e.g., a first linear polarization aligned along a first direction), and the second portion of the deflected light having a second polarization of a second type (e.g., a second linear polarization aligned along a second direction). The second optical component 416 may be configured to absorb or reflect the second portion of the deflected light (traveling in the second direction 410e) having the second polarization of the second type. The second optical component 416 may be configured to let through the first portion of the deflected light (traveling in the first direction 408e) having the first polarization of the second type.

In some aspects, the second optical component 416 may be configured to absorb or reflect the second portion of the deflected light having the second linear polarization aligned along the second direction (e.g., along the horizontal direction 254). The second optical component 416 may be configured to let through the first portion of the deflected light having the first linear polarization aligned along the first direction (e.g., perpendicular to the second direction, e.g. along the vertical direction 256).

In some aspects, the second optical component 416 may include a polarizer oriented along a first orientation direction. The first orientation direction may be parallel to a (known) direction along which the first linear polarization of the first portion of the deflected light is aligned (e.g., may be oriented perpendicular to the direction along which the second linear polarization of the second portion of the deflected light is aligned).

By way of illustration, the optical arrangement 412 may be understood, in some aspects, as a polarization filter for circularly polarized light, that lets through light having a desired circular polarization and attenuates or blocks light having a different (circular) polarization. The optical arrangement 412 may also change the polarization type of the light, such that, in some aspects, the light emitted into the field of emission 420 has a polarization type different from the light received at the light deflection device 402, e.g. the emitted light may have a linear polarization.

FIG. 4C shows schematically the light emission system 400 according to various aspects. FIG. 4C includes possible additional components that the light emission system 400 may have.

In some aspects, the light emission system 400 may include a light source 418 configured to emit light towards the field of emission 420 of the light emission system 400 (illustratively, towards the light deflection device 402). The light source 418 may be configured to emit light having a predefined wavelength, for example in the infra-red and/or near infra-red range, such as in the range from about 700 nm to about 5000 nm, for example in the range from about 860 nm to about 1600 nm, or for example at 905 nm or 1550 nm.

The light source 418 may be configured to emit light in a continuous manner or it may be configured to emit light in a pulsed manner, for example the light source 418 may be configured to emit a sequence of light pulses (e.g., a sequence of laser pulses). In some aspects, the light emission system 400 may include more than one light source 418, for example a plurality of light sources 308 each configured to emit light in a respective wavelength range and/or at a respective rate. In some aspects, the light source 418 may include a plurality of light sources (e.g., a plurality of emitter pixels), for example arranged in a one-dimensional or two-dimensional array, to emit light simultaneously or in a sequential manner. In some aspects, the light source 418 may be configured to emit polarized light, e.g. light having a polarization of a second type (e.g., linearly polarized light).

In some aspects, the light source 418 may include a laser source (or a plurality of laser sources). By way of example the light source 418 may include one or more laser diodes, e.g. one or more edge-emitting laser diodes or one or more vertical cavity surface emitting laser diodes. As another example, the light source 418 may include a laser bar.

In some aspects, the light emission system 418 may include a (third) optical component 422 configured as the optical component 320 described in relation to FIG. 3C.

The third optical component 422 may be configured to receive the light emitted by the light source 418 (e.g., the optical component 422 may be arranged optically downstream of the light source 418), and may be configured to change a type of the polarization of the received light. Illustratively, the light source 418 may be configured to emit light having a polarization of a second type, and the optical component 422 may be configured to convert the polarization of the received light from the second polarization type to a first polarization type. In FIG. 4C, the optical component 422 is shown as being separate from the light source 418 (and from the light deflection device 402), it is however understood that the optical component 422 may also be integrated into the light source 418 (or into the light deflection device 402), or may be dispensed with in case the light source 418 is adapted to emit light of a desired polarization type.

In some aspects, the optical component 422 may be configured to convert linearly polarized light emitted by the light source 418 into circularly polarized light. The optical component 422 may be configured to output light (e.g., circularly polarized light) towards the light deflection device 402, e.g. the optical component 422 may be arranged optically upstream of the light deflection device 402.

In some aspects, the light emission system 400 may include a switchable (fourth) optical component 424 configured to change one or more properties of a polarization of light received at the switchable optical component 424. The switchable optical component 424 may be configured as the switchable optical component 340 described in relation to FIG. 3E. In the configuration shown in FIG. 4C, the switchable optical component 424 may be configured to receive the deflected light and may be configured to change one or more properties of the deflected light (e.g., the first polarization of the first portion and the second polarization of the second portion). In some aspects, the switchable optical component 424 may be integrated into the light deflection device 402. The switchable optical component may be arranged optically downstream of the light deflection device 402 and optically upstream of the optical arrangement 412.

In some aspects, the switchable optical component 424 may be configured (e.g., in a first state) to change the first polarization of the first portion of the deflected light to a (first) predefined polarization in case the first polarization is different from the (first) predefined polarization or to leave the first polarization unaltered in case the first polarization is equal to the (first) predefined polarization. Illustratively, the switchable optical component 424 may be configured to change the first polarization of the first portion such that the first portion may be let through by the optical arrangement 412. The switchable optical component 424 may be configured to change the second polarization of the second portion of the deflected light to a (second) predefined polarization such that the second portion may be attenuated or blocked by the optical arrangement 412. In some aspects, the (first) predefined polarization may be a predefined (first) circular polarization having a predefined (first) handedness. Illustratively, the switchable optical component 424 may be configured (in a first state) to change a handedness of the polarization of the deflected light (e.g., to change the first handedness of the first polarization and the second handedness of the second polarization).

In some aspects, the switchable optical component 424 may be controlled in accordance with a light deflection device 402, e.g. in accordance with a known polarization that the light output by the light deflection device 402 in the first direction 408e has or will have.

By way of illustration, the switchable optical component 424 may provide that the light deflected in the first direction 408e arriving at the optical arrangement 412 has a predefined polarization (e.g., a circular polarization with a predefined handedness), such that it may be let through by the optical arrangement 412. The switchable optical component 424 may be dispensed with, for example, in case the light deflection device 402 is configured such that the light deflected into the first direction 408e already has the desired polarization. The switchable optical component 424 may provide that the light deflected in the second direction 410e arriving at the optical arrangement 412 has a predefined polarization (e.g., opposite to the predefined polarization of the light traveling in the first direction 408e), such that it may be attenuated or blocked by the optical arrangement 412.

It is understood that the light emission system 400 may include additional components not shown in FIG. 4A to FIG. 4C. By way of example, the light emission system may include additional optical components for collimating the light emitted by the light source 418, such as a slow axis collimator and a fast axis collimator. As another example, the light emission system 400 may include additional components for further controlling the emission direction of the light, such as a microelectromechanical system device (e.g., a MEMS mirror) or a metamaterial surface.

FIG. 5A to FIG. 5D each shows a light detection system 500 in a schematic view according to various aspects. The light detection system 500 may be for use in a LIDAR system, e.g. the light detection system 500 may be an exemplary implementation of the light detection system 204 of the LIDAR system 200 described in relation to FIG. 2.

The light detection system 500 may include a (first) optical component 502 configured to receive light from a field of view 520 of the light detection system 500 (e.g., from a field of view of a LIDAR system, e.g. from the field of view 206). The first optical component 502 may be configured to receive polarized light from the field of view 520. In some aspects, the polarized light may have a polarization of a second type, for example a linear polarization, as described in further detail below.

The first optical component 502 may be configured to convert a type of the polarization of the light received from the field of view 520. The first optical component 502 may be configured as the optical component 320 described in relation to FIG. 3C. In the exemplary configuration described herein, the first optical component 502 may be configured to convert the type of the polarization of the received light from the second type into a first type. In some aspects, the light received at the first optical component 502 may have a linear polarization, and the first optical component 502 may be configured to convert the linear polarization into a circular polarization, in other words to convert the linearly polarized light into circularly polarized light.

In some aspects, the light received from the field of view 520 may arrive from more than one direction. The light received from the field of view 520 may include a first portion arriving from a first direction 504r (in some aspects, corresponding to a main emission direction into which light was emitted from the LIDAR system). The received light may further include one or more other portions arriving from one or more other directions (in some aspects, corresponding to further emission directions into which light was emitted from the LIDAR system), for example a second portion arriving from a second direction 5o6r (e.g. corresponding to a secondary emission direction).

In some aspects, the light received from the field of view 520 may have more than one polarization, e.g. light arriving from different directions may have a different mix of polarization. In the exemplary configuration described herein, the light received at the first optical component 502 from the field of view 520 may include a first portion (e.g., arriving from the first direction 504r) having a first polarization and a second portion (e.g., arriving from the second direction 506r) having a second polarization. The first polarization and the second polarization may be of the second type. The first polarization may be different from the second polarization, e.g. in at least one property (for example, in a direction along which the polarization is aligned in case the first and second polarizations are linear polarizations).

In some aspects, the first polarization of the second type may be a first linear polarization aligned along a first direction, for example aligned along a same direction as the polarization of light emitted into a main direction (e.g., in the first direction 408e). The second polarization of the second type may be a second linear polarization aligned along a second direction, for example aligned along a same direction as the polarization of light emitted into a secondary direction (e.g., in the second direction 410e). The first direction may be at an angle with the second direction, e.g. may be perpendicular to the second direction.

In some aspects, the first optical component 502 may be configured such that a handedness of a circular polarization of light output by the first optical component 502 may be in accordance with the direction along which the linear polarization of the light received at the first optical component 502 is aligned. In the exemplary configuration described herein, the first optical component 502 may be configured to convert the first linear polarization to a first circular polarization with a first handedness, and the second linear polarization to a second circular polarization with a second handedness. The second handedness may be opposite the first handedness (e.g., the first portion of the received light may be converted into right-handed circularly polarized light, and the second portion of the received light may be converted into left-handed circularly polarized light, as an example).

In some aspects, the first optical component 502 may include a quarter-wave plate having an optic axis oriented at 450 with respect to a known direction along which the first linear polarization of the first portion of the received light is aligned. In some aspects, the quarter-wave plate may have an optic axis oriented perpendicular to the optic axis of a quarter-wave plate of an optical arrangement of a light emission system of the LIDAR system in which the light detection system 500 is included.

Orienting the optic axis of the quarter-wave plate perpendicular to the optic axis of a quarter-wave plate at the emitter side of a LIDAR system may provide a reduction in the amount of light originating from retroreflective (and mirroring) objects that is delivered to a detector of the light detection system. With this configuration, the light originating from retroreflective objects, which may retain the original (linear) polarization of the emitted light, may be filtered out (e.g., by the optical arrangement 512 described below) prior to being detected. Light from said retroreflective objects may be some order of magnitude greater than light from diffuse reflective objects, and may be attenuated in this configuration, thus requiring less dynamic range at the detector.

In some aspects, the light detection system 500 may include a light deflection device 508 configured to perform polarization-based control of a propagation direction of light arriving at the light deflection device 5o8. The light deflection device 508 may be configured as the light deflection device 300 described in relation to FIG. 3A and FIG. 3B. The light deflection device 508 may be configured to receive the light output by the first optical component 502. The light deflection device 508 may be configured to deflect the light output by the first optical component 502 in accordance with the polarization of the light output by the first optical component 502. The light deflection device 508 may be configured to deflect the light towards a detector of the light detection system 500, described in further detail below.

In some aspects, e.g. in case a LIDAR system includes a light detection system and a light emission system (e.g., the light detection system 500 and the light emission system 400), a common light deflection device may be provided for both light detection and light emission. Illustratively, in some aspects, a LIDAR system may include a common light deflection device (e.g., a common liquid crystal polarization grating) for controlling the direction of light emitted into the field of view and for controlling the direction of light received from the field of view. Further illustratively, in some aspects, the light deflection device 508 of the light detection system 500 and the light deflection device 412 of the light emission system 400 may be understood as a single light deflection device.

As described above, the light output by the first optical component 502 may include a first portion having a first polarization of the first type and a second portion having a second polarization of the first type. The first polarization may differ from the second polarization in such a way that the light deflection device 508 deflects the first portion and the second portion by an opposite angle with respect to the optical axis of the light deflection device 5o8. The light deflection device 508 may thus deflect the first portion and the second portion towards a same direction downstream of the light deflection device 5o8. Illustratively, the deflected light output by the light deflection device 508 may include a first portion having a first polarization of the first type and a second portion having a second polarization of the first type, traveling along a same direction (e.g., the deflected light may include light having first and second circular polarization with opposite handedness).

The light detection system 500 shown in FIG. 5A and further detailed below with reference to FIG. 5B to FIG. 5D, may provide polarization-based detection of light. The light detection system 500 may be used, for example, for detection of linearly polarized light that may be received and directed towards a detector of the light detection system 500.

FIG. 5B, FIG. 5C, and FIG. 5D each shows the light detection system 500 in a schematic view in accordance with various aspects. In FIG. 5B to FIG. 5D are illustrated possible additional components that the light emission system 500 may have. It is understood that the configurations shown in FIG. 5B to FIG. 5D are only an example, and the light detection system 500 may include additional, less, or alternative components with respect to those shown.

In some aspects, as shown for example in FIG. 5B, the light detection system 500 may include a detector 510 configured to detect light. The detector 510 may include one or more photo diodes (e.g., the detector 510 may include at least one of a pin photo diode, an avalanche photo diode, or a single photon avalanche photo diode). The one or more photo diodes may be arranged in a one-dimensional or two-dimensional array. The one or more photo diodes may be configured to generate a signal (e.g., an electrical signal, such as a current) in response to light impinging onto the detector 510.

In some aspects, as shown for example in FIG. 5B, the light detection system 500 may include an optical arrangement 512 configured to attenuate or block light that arrived at the detection system 500 from a direction other than a predefined direction (e.g., other than a main emission direction). Illustratively, the optical arrangement 512 may be configured to attenuate or block the second portion of the light received at the light detection system 500 from the second direction 5o6r, and to let through the first portion of the light received at the light detection system 500 from the first direction 504r. The optical arrangement 512 may be configured as the optical arrangement 412 described in relation to FIG. 4A to FIG. 4C. The optical arrangement 512 may be configured to receive the light deflected by the light deflection device 508, e.g. the optical arrangement 512 may be arranged optically downstream of the light deflection device 508. The optical arrangement 512 may provide (further) attenuation of light originating from reflection of light emitted into an undesired (secondary) direction.

In some aspects, the optical arrangement 512 may include a (second) optical component 514 configured to change a type of the polarization of light arriving at the second optical component 514. The second optical component 514 may be configured as the optical component 320 described in relation to FIG. 3C.

In the configuration described herein, the second optical component 514 may be configured to convert the type of the polarization of the deflected light from the first type to the second type. Illustratively, the second optical component 514 may be configured to convert the type of the first polarization of the first portion of the deflected light and the type of the first polarization of the first portion of the deflected light from the first type to the second type. In some aspects, the second optical component 514 may be configured to convert the first circular polarization of the first portion of the deflected light into a first linear polarization aligned into a first direction (in accordance with the first handedness), and the second circular polarization of the second portion of the deflected light into a second linear polarization aligned into a second direction (in accordance with the second handedness). The second direction may be perpendicular to the first direction.

In some aspects, the optical arrangement 512 may include a (third) optical component 516 configured to let through, absorb, or reflect light received at the third optical component 516 in accordance with the polarization of the received light. The third optical component 516 may be configured as the optical component 330 described in relation to FIG. 3D. In some aspects, the third optical component 516 may be configured to receive the light output by the second optical component 514, illustratively the third optical component 516 may be arranged optically downstream of the second optical component 514.

The third optical component 516 may be configured to absorb or reflect the second portion of the light output by the second optical component 514 having the second polarization of the second type. The third optical component 516 may be configured to let through the first portion of the light output by the second optical component 514 having the first polarization of the second type.

In some aspects, the third optical component 516 may be configured to absorb or reflect the second portion of the light output by the second optical component 514 having the second linear polarization aligned along the second direction (e.g., along the horizontal direction 254). The third optical component 516 may be configured to let through the first portion of the light output by the second optical component 514 having the first linear polarization aligned along the first direction (e.g., perpendicular to the second direction, e.g. along the vertical direction 256).

In some aspects, the third optical component 516 may include a polarizer oriented along an orientation direction parallel to a (known) first direction along which the light arriving at the light detection system 500 from the first direction 504r is aligned.

In some aspects, as shown for example in FIG. 5B, the light detection system 500 may include a (first) switchable optical component 518 configured to change one or more properties of a polarization of light received at the switchable optical component 518. In some aspects, the switchable optical component 518 may be integrated (e.g., laminated) into the light deflection device 508. The switchable optical component 518 may be arranged optically downstream of the first optical component 502, and optically upstream of the light deflection device 5o8, such that the light arriving at the light deflection device 508 may have a predefined polarization. Illustratively, the first switchable optical component 518 may be configured (e.g., in a first state) to change the polarization of the light output by the first optical component 502 to a predefined polarization or (e.g., in a second state) to leave the polarization unaltered in case the polarization of the light output by the first optical component 502 is equal to the predefined polarization. In some aspects, the predefined polarization may be a predefined circular polarization having a predefined handedness. The optical components 502 and 518 may also be realized in one single device fulfilling both functions.

In some aspects, as shown for example in FIG. 5C, the light detection system 500 may include a (fourth) optical component 522. The fourth optical component 522 may be configured to let through, absorb, or reflect light received at the fourth optical component 522 in accordance with the polarization of the received light. The fourth optical component 522 may be configured as the optical component 330 described in relation to FIG. 3D. The fourth optical component 522 may be arranged optically upstream of the first optical component 502, e.g. may receive light from the field of view 520.

The fourth optical component 522 may be configured to absorb or reflect light having a polarization different from the polarization of the light arriving at the light detection system from a main direction, e.g. from the first direction 504r. The fourth optical component 522 may be configured to absorb or reflect a portion of the light received at the light detection system 500 from the field of view 520 having different polarization with respect to a known polarization (for example, a known polarization of light emitted towards a main emission direction by a light emission system of the LIDAR system). In the exemplary configuration described herein, the fourth optical component 522 may be configured to absorb or reflect the second portion of the received light having the second polarization of the second type (e.g., the light arriving from the second direction 5o6r). The fourth optical component 522 may be configured such that the first portion (arriving from the first direction 504r) having the first (e.g., known) polarization (of the second type) may pass through the fourth optical component 522 substantially unaltered. In some aspects, the fourth optical component 522 may be configured to absorb or reflect the second portion of the received light having the second linear polarization directed along the second direction. The fourth optical component 522 may provide (further) attenuation of light emitted into an undesired (e.g., secondary) direction, allowing the light emitted into the desired (main) direction to pass through. The fourth optical component 522 may provide a strong attenuation of light originating from diffuse reflective objects arranged along the second direction.

In some aspects, the fourth optical component 522 may include a polarizer oriented along an orientation direction parallel to a (known) direction along which a linear polarization of the first portion of the received light is aligned, e.g. parallel to a (known) direction along which a linear polarization of light emitted into a first direction is aligned. In some aspects, the polarizer may be oriented along an orientation direction perpendicular to the orientation direction of a polarizer of an optical arrangement of a light emission system of the LIDAR system in which the light detection system is included.

In some aspects, as shown for example in FIG. 5D, the light detection system 500 may include a (second) switchable optical component 524 configured to change one or more properties of a polarization of light received at the switchable optical component 524. The switchable optical component 524 may be configured as the switchable optical component 340 described in relation to FIG. 3E. In the configuration shown in FIG. 5D, the switchable optical component 524 may be configured to receive the light from the field of view 520 and may be configured to change one or more properties of the received light (e.g., the first polarization of the first portion and the second polarization of the second portion). In some aspects, the switchable optical component 524 may be arranged optically upstream of the third optical component 522.

In some aspects, the switchable optical component 524 may be configured (e.g., in a first state) to change one or more properties of the first polarization of the first portion of the received light, and one or more properties of the second polarization of the second portion of the received light. In some aspects, in case the received light has linear polarization, the switchable optical component 524 may be configured (e.g., in the first state) to change the first direction along which the first linear polarization is aligned and to change the second direction along which the second linear polarization is aligned. The first direction may be changed into the second direction, and the second direction may be changed into the first direction. In this configuration, it may be possible to determine the amount of light arriving at the light detection system 500 that maintained its polarization and the amount of light (arriving from the same direction) that didn't maintain its polarization. This information may be used to determine the presence of one or more diffuse reflective objects along that direction. Illustratively, in combination with the other components of the light detection system 500, the light coming from diffuse reflective objects may be let through to the detector 510, to determine the presence of (and recognize or identify) diffuse reflective objects.

FIG. 6A, FIG. 6B, FIG. 6C, and FIG. 6D each shows a respective LIDAR system 600a, 600b, 600c, 600d in a schematic view according to various aspects. The LIDAR system 600a, 600b, 600c, 600d may be an exemplary implementation of the LIDAR system 200 described in relation to FIG. 2. The LIDAR system 600a, 600b, 600c, 600d may include a respective light emission system 602a, 602b, 602c, 602d, which may be an exemplary implementation of the light emission system 202 described in relation to FIG. 2 and of the light emission system 400 described in relation to FIG. 4A to FIG. 4C. The LIDAR system 600a, 600b, 600c, 600d may include a respective light detection system 604a, 604b, 604c, 604d, which may be an exemplary implementation of the light detection system 204 described in relation to FIG. 2 and of the light detection system 500 described in relation to FIG. 5A to FIG. 5D.

The light emission system 602a, 602b, 602c, 602d may include a light source 606 (e.g., a laser source) configured to emit linearly polarized light towards a field of view 630 of the LIDAR system 600a, 600b, 600c, 600d.

The light emission system 602a, 602b, 602c, 602d may include an optical component 608 (e.g., configured as the optical component 320), such as a quarter-wave plate, configured to convert the linearly polarized light emitted by the light source 606 into circularly polarized light. The radiation at the output of the transmitter unit 606 can be converted into linearly polarized light by the lambda quarter plate 608.

The light emission system 602a, 602b, 602c, 602d may include a light deflection device 610, e.g. a liquid crystal polarization grating, configured to receive the circularly polarized light and to deflect the received light towards a (first or main) emission direction 612e associated with a handedness of the circular polarization. The deflected light may include a first portion deflected towards the first emission direction 612e and a second portion deflected towards a second (or secondary) emission direction 614e.

The light emission system 602a, 602b, 602c, 602d may include an optical component 616 (e.g., configured as the optical component 320), such as a quarter-wave plate, arranged optically downstream of the liquid crystal polarization grating 610 and configured to convert the circularly polarized light output by the liquid crystal polarization grating 610 into linearly polarized light.

The light emission system 602a, 602b, 602c, 602d may include an optical component 618 (e.g., configured as the optical component 330), such as a polarizer, arranged optically downstream of the quarter-wave plate 616 and configured to absorb or reflect a portion of the light output by the quarter-wave plate 616 having a linear polarization different from the linear polarization of the light deflected towards the first direction 612e. The polarization filter 618 may be used to filter out most of the radiation in the secondary direction, as this has the other polarization direction than the main beam.

In some aspects, not show in the FIG. 6A to FIG. 6D, the light emission system 602a, 602b, 602c, 602d may include a switchable optical component (e.g., configured as the optical component 340), such as a switchable half-wave plate, arranged between the liquid crystal polarization grating 610 and the quarter-wave plate 616, and configured to change (in a first state) the handedness of the circularly polarized light output by liquid crystal polarization grating 610. This switchable component may be integrated in the liquid crystal polarization grating 610 as one additional switchable liquid crystal layer.

The light detection system 604a, 604b, 604c, 604d may receive light from the field of view 630 of the LIDAR system 600a, 600b, 600c, 600d, for example light arriving from a first (main) direction 612r (originating from the light emitted into the first direction 612e), and light arriving from a second (secondary) direction 614r (originating from the light emitted into the first direction 614r). In case of reflection from retroreflective objects, the light arriving at the light detection system 604a may maintain the polarization (as shown in FIG. 6A). In the configuration in FIG. 6A, most of the reflected light from retroreflective objects from the main direction is transmitted through the polarizer in front of the detector. In case of reflection from diffuse reflective objects, the light arriving at the light detection system 604b, 604c, 604d may include components with different polarization, for example a component with a linear polarization aligned into a first direction and other component with a linear polarization aligned into a second direction (as shown in FIG. 6B to FIG. 6D).

The light detection system 604a, 604b, 604c, 604d may include an optical component 620 (e.g., configured the optical component 320), such as a quarter-wave plate, configured to convert linearly polarized light received from the field of view 430 into circularly polarized light. In some aspects, for example shown in FIG. 6B, an optic axis of the quarter-wave plate 620 may be oriented perpendicularly to an optic axis of the quarter-wave plate 616, to provide (further) attenuation of the light emitted into and arriving from the secondary direction 614e, 614r. This configuration may also provide attenuating light coming from retroreflective objects.

Illustratively, to reduce the proportion of light coming from retroreflective surfaces that retains most of its polarization, the lambda quarter plate 620 may be rotated by 90° in the receiver path. The light from polarization-preserving reflecting objects from the main direction is filtered out by the filter 626 in front of the detector 628. However, light from the secondary direction (which has the opposite polarization of the radiation emitted in that direction—perpendicular in FIG. 6B) is then also efficiently directed onto the detector 628, which may have an unfavourable effect on the crosstalk. The advantage of the configuration illustrated in FIG. 6B is that the signals from retroreflective objects or specularly reflective objects, which on the one hand can be several orders of magnitude stronger than diffusely reflected signals, are strongly attenuated. As a result, the dynamic range for which the detector 628 should be designed may become significantly smaller.

The light detection system 604a, 604b, 604c, 604d may include a light deflection device 622, e.g. a liquid crystal polarization grating, configured to receive the circularly polarized light and to deflect the received light towards a detector 628 of the light detection system 604a, 604b, 604c, 604d.

In some aspects, not show in the FIG. 6A to FIG. 6D, the light detection system 604a, 604b, 604c, 604d may include a switchable optical component (e.g., configured as the optical component 340), such as a switchable half-wave plate, arranged between the liquid crystal polarization grating 622 and the quarter-wave plate 620, and configured to change (in a first state) the handedness of the circularly polarized light output by the quarter-wave plate 620.

The light detection system 604a, 604b, 604c, 604d may include an optical component 624 (e.g., configured the optical component 320), such as a quarter-wave plate, configured to convert circularly polarized light received from the liquid crystal polarization grating 622 into linearly polarized light.

The light detection system 604a, 604b, 604c, 604d may include an optical component 626 (e.g., configured as the optical component 330), such as a polarizer, arranged optically downstream of the quarter-wave plate 624 and configured to absorb or reflect a portion of the light output by the quarter-wave plate 624 having a linear polarization different from the linear polarization of the light received from the first direction 612r.

In some aspects, as shown for example in FIG. 6C and FIG. 6D, the light detection system 604c, 604d may include an optical component 632 (e.g., configured as the optical component 330), such as a polarizer, arranged optically upstream of the quarter wave plate 620 and configured to absorb or reflect the second portion of the light received at the light detection system 604c, 604d from the second direction 614r. In some aspects, for example as shown in FIG. 6C and FIG. 6D, the polarizer 632 may be oriented perpendicularly to the polarizer 618, to provide (further) attenuation of the light emitted into and arriving from the secondary direction 614e, 614r. This configuration may also provide attenuating light coming from retroreflective objects, to assist or enhance a detection of light coming from diffuse reflective objects (which includes also light with polarization different from the emitted light).

Illustratively, in the configuration in FIG. 6C a polarization filter 632 may be placed in front of the receiver path to filter out the light from the secondary direction. The polarization filter 632 may filter out the polarization direction of the light coming from the secondary direction, while letting through the polarization direction of the light coming from the main direction, which is efficiently guided towards the detector 628. The advantage of the configuration shown in FIG. 6C is a more strongly suppressed signal from diffusely reflective objects from the secondary direction.

In some aspects, as shown for example in FIG. 6D, the light detection system 604d may include a switchable optical component 634 (e.g., configured as the optical component 340), such as a switchable half-wave plate, arranged optically upstream of the polarizer 632 and configured to change (in a first state) the direction along which the linear polarization of the light received at the light detection system 604d is received. This may provide detecting the portion of the polarization of the received light that did not maintain the polarization of the emitted light, to assist a detection of diffuse reflective objects.

Illustratively, the additional switchable lambda-half plate 634 enables to control (e.g., to switch) the polarization that is transmitted to the detector. The advantage of the configuration shown in FIG. 6D that the polarization-maintaining fraction of the reflecting objects can be estimated and thus additional information is available for object detection. For example, it is possible to distinguish whether a reflection originates from a retroreflective traffic sign or from a truck, which could help preventing traffic accidents in case the system is implemented in a vehicle.

In the following, various aspects of this disclosure will be illustrated.

Example 1 is a LIDAR system including a light emission system, the light emission system including: a light deflection device configured to receive polarized light, and configured to deflect the received light towards a first direction in accordance with the polarization of the received light; and an optical arrangement configured to absorb or reflect a second portion of the light deflected by the light deflection device travelling in a second direction, based on a polarization of the second portion of the deflected light.

In Example 2, the subject-matter of example 1 may optionally further include that the light deflection device is configured to deflect the received light at a deflection angle that is dependent on a first polarization of the received light.

In Example 3, the subject-matter of example 1 or 2 may optionally further include that the light deflected by the light deflection device has a polarization of a first type, and that the optical arrangement includes a first optical component configured to convert the type of the polarization of the deflected light from the first type to a second type, and that the optical arrangement includes a second optical component configured to absorb or reflect the second portion of the deflected light having a second polarization of the second type.

In Example 4, the subject-matter of example 3 may optionally further include that the first polarization is a first circular polarization with a first handedness and the second polarization is a second circular polarization with a second handedness, that the first optical component is configured to convert the first circular polarization to a first linear polarization and the second circular polarization to a second linear polarization, and that the second optical component is configured to absorb or reflect the second portion of the deflected light having the second linear polarization.

In Example 5, the subject-matter of example 4 may optionally further include that the first optical component is configured such that a direction along which the first linear polarization is aligned is in accordance with the first handedness of the first circular polarization, and a direction along which the second linear polarization is aligned is in accordance with the second handedness of the second circular polarization.

In Example 6, the subject-matter of example 5 may optionally further include that the direction along which the second linear polarization is aligned is perpendicular to the direction along which the first linear polarization is aligned.

In Example 7, the subject-matter of any one of examples 3 to 6 may optionally further include that the second optical component is arranged optically downstream of the first optical component.

In Example 8, the subject-matter of any one of examples 1 to 7 may optionally further include that the light deflection device is configured such that the deflected light includes a first portion aligned towards the first direction and the second portion aligned towards the second direction.

In Example 9, the subject-matter of any one of examples 1 to 8 may optionally further include that the light deflection device is configured such that the deflected light of the second portion has a second polarization.

In Example 10, the subject-matter of example 9 may optionally further include that the first polarization is a first circular polarization having a first handedness, and that the second polarization is a second circular polarization having a second handedness opposite the first handedness.

In Example 11, the subject-matter of any one of examples 1 to 10 may optionally further include that the light deflection device includes a polarization grating (as an example, a liquid crystal polarization grating).

In Example 12, the subject-matter of any one of examples 3 to 11 may optionally further include that the first optical component includes a quarter-wave plate, and that the second optical component includes a polarizer.

In Example 13, the subject-matter of example 12 may optionally further include that the polarizer is oriented along a first orientation direction parallel to a direction along which the first linear polarization of the first portion of the deflected light is aligned.

In Example 14, the subject-matter of any one of examples 1 to 13 may optionally further include that the light emission system further includes a switchable optical component, the switchable optical component being configured to receive the deflected light and to change one or more properties of the polarization of the deflected light

In Example 15, the subject-matter of example 14 may optionally further include that switchable optical component is configured to change the first polarization of the first portion of the deflected light to a predefined polarization in case the first polarization is different from the predefined polarization or to leave the first polarization substantially unaltered in case the first polarization is equal to the predefined polarization.

In Example 16, the subject-matter of example 14 or 15 may optionally further include that the predefined polarization is a predefined circular polarization having a predefined handedness.

In Example 17, the subject-matter of any one of examples 14 to 16 may optionally further include that the switchable optical component is arranged optically downstream of the light deflection device and optically upstream of the optical arrangement.

In Example 18, the subject-matter of any one of examples 14 to 17 may optionally further include that the switchable optical component is integrated into the light deflection device.

In Example 19, the subject-matter of any one of examples 14 to 18 may optionally further include that the switchable optical component includes a switchable liquid crystal component.

In Example 20, the subject-matter of any one of examples 14 to 19 may optionally further include that the switchable optical component includes a switchable half-wave plate.

In Example 21, the subject-matter of any one of examples 1 to 20 may optionally further include that the light emission system includes a light source configured to emit light towards a field of emission of the light emission system.

In Example 22, the subject-matter of example 21 may optionally further include that the light source includes a laser source.

In Example 23, the subject-matter of example 21 or 22 may optionally further include that the light emission system includes a further optical component configured to receive the light emitted by the light source, and configured to change a type of the polarization of the received light.

In Example 24, the subject-matter of example 23 may optionally further include that the light source is configured to emit light having a linear polarization, and that the further optical component is configured to convert the linear polarization of the received light into a circular polarization.

In Example 25, the subject-matter of example 23 or 24 may optionally further include that the further optical component includes a quarter-wave plate.

Example 26 is a light emission system for use in a LIDAR system, the light emission system including: a light deflection device configured to receive polarized light, and configured to deflect the received light towards a first direction in accordance with the polarization of the received light; and an optical arrangement configured to absorb or reflect a second portion of the light deflected by the light deflection device travelling in a second direction, based on a polarization of the second portion of the deflected light.

Example 27 is a method of emitting light in a LIDAR system, the method including: deflecting light towards a first direction in accordance with a polarization of the light; and absorbing or reflecting a second portion of the deflected light traveling in a second direction, based on a polarization of the second portion of the deflected light.

Example 28 is a LIDAR system including a light detection system, the light detection system including: a first optical component configured to receive polarized light from the field of view of the LIDAR system, the first optical component being configured to convert a type of the polarization of the received light; and a light deflection device configured to deflect light output by the first optical component in accordance with a polarization of the light output by the first optical component.

In Example 29, the subject-matter of example 28 may optionally further include that the polarized light has a polarization of a second type, and that the first optical component is configured to convert the type of the polarization of the received light from the second type into a first type.

In Example 30, the subject-matter of example 28 or 29 may optionally further include that the light received from the field of view of the LIDAR system includes a first portion having a first polarization of the second type and a second portion having a second polarization of the second type.

In Example 31, the subject-matter of example 30 may optionally further include that the first polarization of the second type is a first linear polarization aligned along a first direction and the second polarization of the second type is a second linear polarization aligned along a second direction, perpendicular to the first direction.

In Example 32, the subject-matter of example 31 may optionally further include that the first optical component is configured to convert the first linear polarization to a first circular polarization with a first handedness, and the second linear polarization to a second circular polarization with a second handedness opposite the first handedness.

In Example 33, the subject-matter of any one of examples 28 to 32 may optionally further include that the deflected light output by the light deflection device includes a first portion having a first polarization of the first type and a second portion having a second polarization of the first type.

In Example 34, the subject-matter of example 33 may optionally further include that the first polarization of the first type is a first circular polarization with a first handedness and the second polarization of the first type is a second circular polarization with a second handedness, opposite to the first handedness.

In Example 35, the subject-matter of any one of examples 28 to 34 may optionally further include that the first optical component includes a quarter-wave plate.

In Example 36, the subject-matter of example 35 may optionally further include that an optic axis of the quarter wave plate is oriented at 450 with respect to the first direction along which the first linear polarization of the first portion of the received light is aligned.

In Example 37, the subject-matter of any one of examples 28 to 36 may optionally further include that the light deflection device includes a polarization grating (as an example, a liquid crystal polarization grating).

In Example 38, the subject-matter of any one of examples 28 to 37 may optionally further include that the light detection system further includes a first switchable optical component arranged optically downstream of the first optical component and configured to change the polarization of the light output by the first optical component to a predefined polarization

In Example 39, the subject-matter of example 38 may optionally further include that the first switchable optical component is configured to change the polarization of the light output by the first optical component in case the polarization of the light is different from a predefined polarization, and is configured to leave the polarization unaltered in case the polarization is equal to the predefined polarization.

In Example 40, the subject-matter of example 38 or 39 may optionally further include that wherein the predefined polarization is a predefined circular polarization having a predefined handedness.

In Example 41, the subject-matter of any one of examples 38 to 40 may optionally further include that the first switchable optical component includes a switchable half-wave plate.

In Example 42, the subject-matter of any one of examples 28 to 41 may optionally further include that the light detection system further includes an optical arrangement configured to receive the light deflected by the light deflection device, the optical arrangement including a second optical component configured to convert the type of the polarization of the deflected light from the first type to the second type, and a third optical component configured to absorb or reflect the second portion of the deflected light having the second polarization of the second type.

In Example 43, the subject-matter of example 42 may optionally further include that the second optical component includes a quarter wave plate, and wherein the third optical component includes a polarizer.

In Example 44, the subject-matter of any one of examples 28 to 43 may optionally further include that the light detection system further includes a detector configured to detect light.

In Example 45, the subject-matter of any one of examples 28 to 44 may optionally further include that the light detection system further includes a fourth optical component arranged optically upstream of the first optical component, the fourth optical component being configured to absorb or reflect the light received from the field of view in accordance with the polarization of the received light.

In Example 46, the subject-matter of example 45 may optionally further include that the fourth optical component is configured to absorb or reflect light having a polarization different from a known polarization of light emitted towards a main emission direction by a light emission system of the LIDAR system.

In Example 47, the subject-matter of example 45 or 46 may optionally further include that the fourth optical component is configured to absorb or reflect the second portion of the received light having the second polarization of the second type.

In Example 48, the subject-matter of example 47 may optionally further include that the fourth optical component is configured to absorb or reflect the second portion of the received light having the second linear polarization aligned along the second direction.

In Example 49, the subject-matter of any one of examples 45 to 48 may optionally further include that the fourth optical component includes a polarizer.

In Example 50, the subject-matter of example 49 may optionally further include that the polarizer is oriented along an orientation direction parallel to a known direction along which the polarization of light emitted towards a main emission direction by a light emission system of the LIDAR system is aligned.

In Example 51, the subject-matter of example 49 or 50 may optionally further include that the polarizer is oriented parallel to the first direction along which the first linear polarization of the first portion of the received light is aligned.

In Example 52, the subject-matter of any one of examples 49 to 51 may optionally further include that the polarizer is oriented perpendicular to a polarizer in an optical arrangement of a light emission system of the LIDAR system.

In Example 53, the subject-matter of any one of examples 45 to 52 may optionally further include that the light detection system further includes a second switchable optical component arranged optically upstream of the fourth optical component, the second switchable optical component being configured to receive light from the field of view and to change one or more properties of the polarization of the received light.

In Example 54, the subject-matter of example 53 may optionally further include that the second switchable optical component is configured to change a direction along which a linear polarization is aligned.

In Example 55, the subject-matter of example 53 or 54 may optionally further include that the second switchable optical component is configured to change the first direction into which the first polarization of the light of the first portion is aligned to the second direction, and to change the second direction into which the second polarization of the light of the second portion is aligned to the first direction.

In Example 56, the subject-matter of any one of examples 53 to 55 may optionally further include that the second switchable optical component includes a switchable half wave plate.

Example 57 is a light detection system for use in a LIDAR system, the light detection system including: a first optical component configured to receive polarized light from the field of view of the light detection system, the first optical component being configured to convert a type of the polarization of the received light; and a light deflection device configured to deflect light output by the first optical component in accordance with the polarization of the light output by the first optical component.

Example 58 is a method for detecting light in a LIDAR system, the method including: receiving polarized light from the field of view of the light detection system; converting a type of the polarization of the received light; and deflecting the converted light in accordance with the polarization of the converted light.

Example 59 is a LIDAR system including a light emission system and a light detection system, the light emission system including: a light deflection device configured to receive polarized light, and configured to deflect the received light towards a first direction in accordance with the polarization of the received light; and an optical arrangement configured to absorb or reflect a second portion of the light deflected by the light deflection device travelling in a second direction, based on a polarization of the second portion of the deflected light; the light detection system including: a first optical component configured to receive polarized light from the field of view of the LIDAR system, the first optical component being configured to convert a type of the polarization of the received light; and a light deflection device configured to deflect light output by the first optical component in accordance with the polarization of the light output by the first optical component.

In Example 60, the subject-matter of example 59 may optionally further include that the optical arrangement of the light emission system includes a first quarter-wave plate having an optic axis oriented along a first direction, and that the first optical component of the light detection system includes a second quarter-wave plate having an optic axis oriented along a second direction perpendicular to the first direction.

In Example 61, the subject-matter of example 59 or 60 may optionally further include that the optical arrangement of the light emission system includes a first polarizer oriented along a first orientation direction, and that the light detection system includes a second polarizer arranged optically upstream of the first optical component and oriented along a second orientation direction perpendicular to the first orientation direction.

Example 62 is a light emission system for use in a LIDAR system, the light emission system including: a liquid crystal polarization grating configured to receive light having a first circular polarization, and configured to deflect the received light towards an emission direction associated with a handedness of the first circular polarization; a quarter-wave plate arranged optically downstream of the liquid crystal polarization grating and configured to convert the first circular polarization of the deflected light into a first linear polarization; and a polarizer arranged optically downstream of the quarter wave plate and configured to absorb or reflect a second portion of the deflected light output by the quarter-wave plate having a second linear polarization different from the first linear polarization.

Example 63 is a light detection system for use in a LIDAR system, the light detection system including: a quarter wave plate configured to receive linearly polarized light from a field of view of the LIDAR system, and configured to convert the linearly polarized light into circularly polarized light; and a liquid crystal polarization grating arranged optically downstream of the quarter wave plate and configured to deflect the circularly polarized light output by the quarter wave plate towards a direction associated with a handedness of the circular polarization of the circularly polarized light.

Example 64 is a LIDAR system including the light emission system of example 62 and/or the light detection system of example 63.

While various implementations have been particularly shown and described with reference to specific aspects, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

1-15. (canceled)

16. A LIDAR system comprising:
a light emission system comprising:
a light deflection device configured to:
receive polarized light; and
deflect the received light towards a first direction in accordance with a polarization of the received light; and
an optical arrangement configured to absorb or reflect a second portion of the light deflected by the light deflection device travelling in a second direction based on a polarization of the second portion of the deflected light.

17. The LIDAR system according to claim 16,
wherein the light deflected by the light deflection device has a first polarization of a first type,
wherein the optical arrangement comprises a first optical component configured to convert the type of the polarization of the deflected light from the first type to a second type, and
wherein the optical arrangement comprises a second optical component configured to absorb or reflect the second portion of the deflected light having a second polarization of the second type.

18. The LIDAR system according to claim 17,
wherein the first polarization is a first circular polarization with a first handedness and the second polarization is a second circular polarization with a second handedness,
wherein the first optical component is configured to convert the first circular polarization to a first linear polarization and the second circular polarization to a second linear polarization, and
wherein the second optical component is configured to absorb or reflect the second portion of the deflected light having the second linear polarization.

19. The LIDAR system according to claim 17, wherein the first optical component comprises a quarter-wave plate, and wherein the second optical component includes a polarizer.

20. The LIDAR system according to claim 16, wherein the light deflection device comprises a liquid crystal polarization grating.

21. A LIDAR system comprising:
a light detection system comprising:
a first optical component configured to:
receive polarized light from a field of view of the LIDAR system, and
convert a type of polarization of the received light; and
a light deflection device configured to deflect light output by the first optical component in accordance with a polarization of light output by the first optical component.

22. The LIDAR system according to claim 21, wherein the polarized light received from the field of view of the LIDAR system comprises a first portion having a first polarization of a second type and a second portion having a second polarization of the second type.

23. The LIDAR system according to claim 22,
wherein the first polarization of the second type is a first linear polarization aligned along a first direction and the second polarization of the second type is a second linear polarization aligned along a second direction, perpendicular to the first direction, and
wherein the first optical component is configured to convert the first linear polarization to a first circular polarization with a first handedness, and the second linear polarization to a second circular polarization with a second handedness opposite the first handedness.

24. The LIDAR system according to claim 21, wherein the first optical component comprises a quarter-wave plate.

25. The LIDAR system according to claim 21, wherein the light deflection device comprises a liquid crystal polarization grating.

26. The LIDAR system according to claim 21,
wherein the light detection system further comprises an optical arrangement configured to receive the light deflected by the light deflection device, and
wherein the optical arrangement comprises:
a second optical component configured to convert a type of the polarization of the deflected light from the first type to the second type, and
a third optical component configured to absorb or reflect a second portion of the deflected light having a second polarization of the second type.

27. The LIDAR system according to claim 21, wherein the light detection system further comprises a fourth optical component arranged optically upstream of the first optical component, the fourth optical component being configured to absorb or reflect a second portion of the received light having a second polarization of a second type.

28. The LIDAR system according to claim 21, wherein the light detection system further comprises a switchable optical component configured to:
receive the light from the field of view,
change a first direction into which a first linear polarization of a first portion of the received light is aligned to a second direction, and
change a second direction into which a second linear polarization of a second portion of the received light is aligned to the first direction.

29. The LIDAR system according to claim 28, wherein the switchable optical component comprises a switchable half-wave plate.

30. A LIDAR system comprising:
a light detection system;
a light emission system comprising:
a first light deflection device configured to:
receive polarized light, and
deflect the received light towards a first direction in accordance with a polarization of the received light; and
an optical arrangement configured to absorb or reflect a second portion of the light deflected by the light deflection device travelling in a second direction, based on a polarization of the second portion of the deflected light,
wherein the light detection system comprises:
a first optical component configured to receive polarized light from a field of view of the LIDAR system, the first optical component being configured to convert a type of the polarization of the received light; and
a second light deflection device configured to deflect light output by the first optical component in accordance with a polarization of the light output by the first optical component.
